(19) United States
(12) Patent Application Publication
(10) Pub. No.: US 2023/0398536 A1
(43) Pub. Date: Dec. 14, 2023

(54) LAB-ON-A-CHIP WITH ELECTRONICALLY-CONTROLLED MECHANICAL FLUID DRIVING SYSTEM

(71) Applicant: BIOTHINK TECHNOLOGIES S.L., SEVILLA (ES)

(72) Inventors: Emilio FRANCO GONZALEZ, Sevilla (ES); Marta MOZO MULERO, Sevilla (ES)

(21) Appl. No.: 17/769,546

(22) PCT Filed: Oct. 15, 2020
(86) PCT No.: PCT/EP2020/079070

§ 371 Date: Apr. 15, 2022

(30) Foreign Application Priority Data
Oct. 18, 2019 (EP) 19382911.6

(51) Int. Cl. B01L 3/00

(52) U.S. Cl. CPC B01L 3/50273; B01L 3/502715; B01L 2200/027; B01L 2300/0816; B01L 2300/0874; B01L 2400/0478; B01L 2300/0672; B01L 2200/143

(57) ABSTRACT

Lab-on-a-chip comprising an upper fluid driving area (3) and another lower area (5) with microfluidic mixing channels (19), wherein the driving area is provided with at least two fluid inlet holes (4) and respective moving plungers (12), each attached to a piston (15) and a driver (14), wherein the drivers (14) are connected to an actuator platform (23) provided with a processor and a motor for actuating the drivers (14) and plungers, and the fluid inlet holes (4) are provided with a closing plug (2) inside. Thus, it is possible to perform several fluid mixing processes while controlling the direction of the movement of the fluid within the microchannels in order to carry out mixtures in less time and space.

### STATE OF THE ART

The present invention belongs to the field of labs-on-chips, and more specifically relates to a lab-on-a-chip comprising a fluid driving system manufactured with biocompatible materials and which makes it possible to mix different fluids, whether they are encapsulated or not.

The invention can be applied to the fields of healthcare, veterinary care, industrial manufacturing, agri-food and pharmaceuticals. For example, it can be used for PCR (polymerase chain reaction) devices, DNA testing, parameter testing systems, whether they are portable or not, such as creatinine or tumour markers, for measuring pH in fluids, for manufacturing gas or contamination sensors, for manufacturing reactors or digesters, for detecting compounds in food, such as volatile compounds in olive oil or for the production and testing of pharmaceuticals.

### BACKGROUND OF THE INVENTION

Research on processes for manufacturing microfluidic devices is currently booming due to their potential application in several large sectors of the market, such as pharmaceuticals and agri-food. In particular, some of the areas of focus of this research include the manufacturing processes of microstructures in polymeric devices, which are increasingly reducing the cost of producing the devices or the encapsulation of reagents within the devices.

One of the most interesting applications of these technologies is the manufacturing of traditional testing systems on a miniaturised scale. This application exhibits some improvements over traditional systems, such as reducing the amount of reagents required, an important part of the cost of current tests; the automation of processes using accompanying electronic systems which have an impact on the process in question by choosing when each step of the process occurs and reading the result once it is completed; faster testing due to the miniaturisation of the amount of fluid involved in the process; the possibility of making the entire system portable in order to conduct testing in places wherein an electrical connection is not available; and, due to all the above improvements, a reduction in the cost of the entire process.

The problems that still arise in the manufacturing of this type of devices occur because the process to join the portions of the circuit are underdeveloped or are provided for non-polymeric materials, and are therefore more expensive; because the biocompatibility of the materials used is not sufficient to allow the incorporation of biological reagents into the devices; because some driving systems require the incorporation of valves, whether they are volatile or not, which are complicated to manufacture from a technical standpoint or leave waste in the channels, which contaminates the reagents which have been incorporated; and that fluid driving systems are not very robust, or require heavy external machinery to operate them, which is improved by the driving process described herein.

These technologies will, in the future, replace traditional testing systems, such as clinical or food testing laboratories, by reducing the cost of testing as we know it today by several orders of magnitude. This will provide faster results, cheaper testing, and will eliminate the need for a second medical consultation wherein a medical team reads the results to the patient.

Most of the steps involved in the development of driving processes go through the development of external pressure sources for the systems and microfluidic connectors to connect such systems, which greatly complicates the diagnostic system. Examples of such systems are those found in patents or patent applications US 20120067433 A1, U.S. Pat. No. 8,747,604 B2, US 20090252629 A1 or US 20160051984 A1. Other researchers have incorporated driving systems within the devices, such as the driving method provided in US 20110151475 A1, wherein the chemical energy of the reagents incorporated into the system itself is used to drive the components. Another solution found, such as the one provided in US 20120090692 A1, involves incorporating deformable elastic elements within chambers intended for this purpose, which, once pressed by an external element, drive the fluids incorporated into the system. As a final example, in the pressurisation system developed in US 2016/0263577 A1, a plunger exerts a force on a folding element containing reagents inside. The drawback of this device is that the volume to be driven is fixed and depends on the design of the plunger. In addition, it is impossible to make the reagent move back with this plunger, which makes mixing different reagents more difficult and makes it impossible to carry out several processes within the same device at the same time.

### SUMMARY OF THE INVENTION

To solve the drawbacks described above, the present invention proposes a lab-on-a-chip comprising a first upper area or driving area (3) provided with at least two fluid driving systems, and a second lower area (5) wherein the microfluidic channels are located in order to mix the fluids (fluid is understood as gases, liquids, emulsions and fluid solids such as sand or dust). In the driving area, at least two moving pistons (15) actuated by two drivers (14) are connected to respective plungers (12) which are responsible for moving the fluids. Each plunger is controlled by electronic means, so that their movement forward or backward within the reagent channel can be controlled with great precision.

These electronic means are located on an actuator platform (23) comprising a motor connected to the drivers which will move the plungers. On the platform, a processor chooses, based on the data coming from the sensors, the driver or drivers to be actuated and the direction the fluid will be driven, the duration thereof, etc.

Both the driving area and the channel area for mixing liquids are made of a biocompatible material including, but not limited to, PMMA (polymethylmethacrylate), polycarbonate, silicon, etc., which prevents the areas from having to be pressurised during or after the manufacturing process. In addition, this prevents volatile or mobile elements from contaminating the reagents.

The proposed invention also prevents the area wherein the fluids move from being contaminated through contact with the moving plungers thanks to the closing plug. Thus, the “mechanical” area is differentiated from the “clean” area, the location of the fluids and the microfluidic channels wherein the fluids are mixed, keeping the latter area sealed and out of reach of contaminants in the plunger area.

Thanks to the incorporation of sensors and electronic actuators in the system, it is possible to detect the position of the fluids in the data collection area to thus send control signals to the mechanical system of the driving system through an accompanying electronic system, which stops the actuation when necessary. This stops the driving when the fluid reaches a certain area of the system. To do so, temperature sensors or other physical parameters are connected to the mechanical system via an electronic board, wherein these parameters are processed and interpreted in a processor.

### BRIEF DESCRIPTION OF THE DRAWINGS

To supplement the description that is being made and in order to aid a better understanding of the features of the invention, a set of drawings has been attached as an integral part of said description, which represent the following by way of illustration and not limitation:

FIG. 1.—Elevation and cross-sectional view of the portions of the lab-on-a-chip of the invention.

FIG. 2.—Details of the driving and data collection areas in the present invention.

FIG. 3.—Shows the manufacturing process of a device according to FIG. 1.

### DESCRIPTION OF THE INVENTION

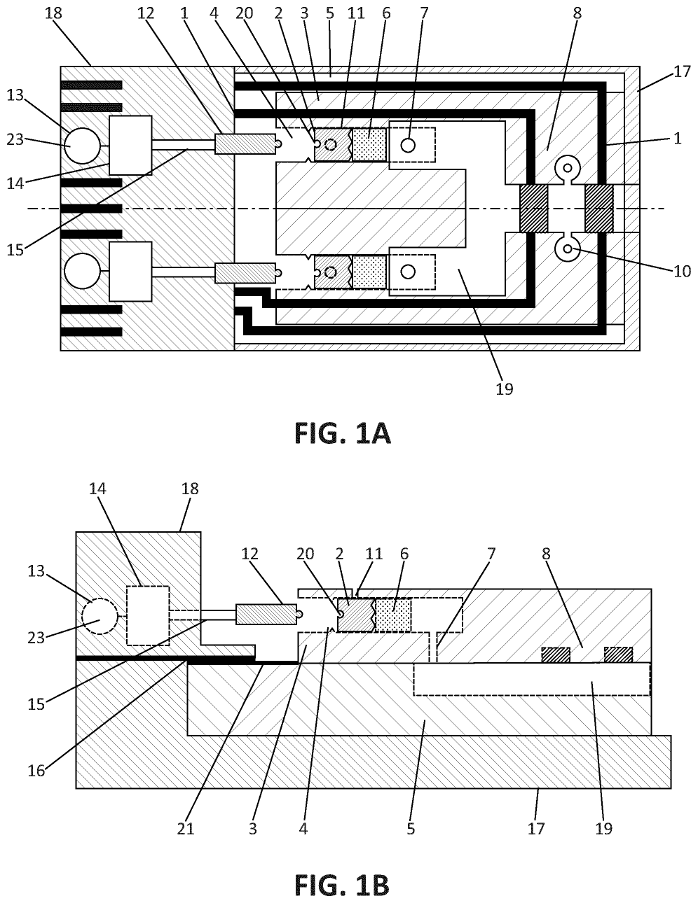

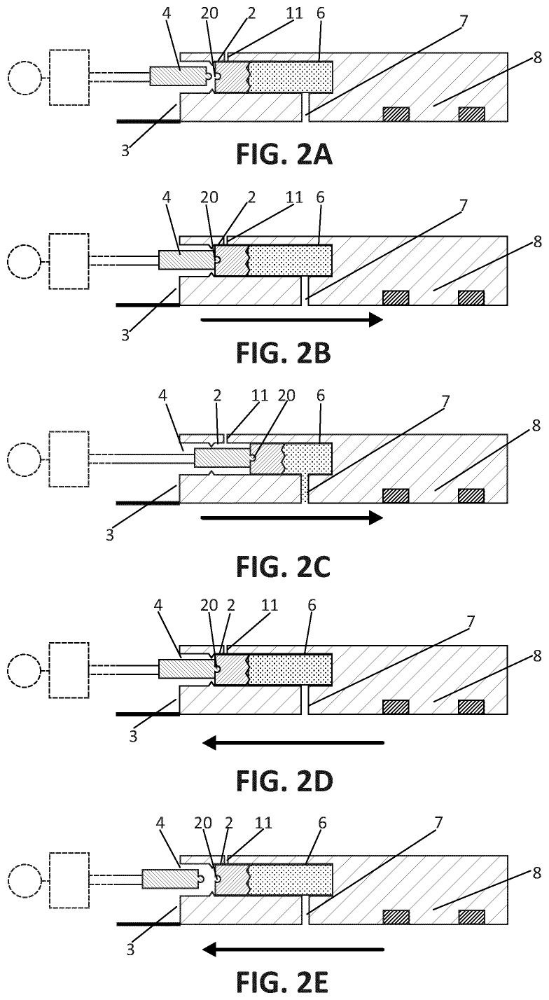

In reference to FIGS. 1 and 2, the invention comprises at least two driving systems in the upper area (3) for driving a fluid (6) and a microfluidic mixing channel (19) in the lower area (5). Each driving system comprises a driver (14), which actuates the piston (15) joined to the plunger (12). The plunger exerts pressure on a closing plug (2) into the fluid inlet hole (4), allowing the fluid to pass through the communication channel (7) between the inlet hole (4) and the microfluidic mixing channel (19). The closing plug (2) can be fitted with a notch (20) attached to a protrusion of the plunger to facilitate the coupling of both elements.

Within the upper area but just above the microfluidic mixing channels (19) a series of sensors (8) are embedded which make up the data collection area. These sensors can be both physical and chemical and communicate their data to an external actuator platform via a communication interface (21). The external actuator platform (23) comprises a single motor attached to drivers (14) connected to each plunger (12) and a processor with a driving process control software. The processor receives signals from the sensors and depending on the information received (temperature, chemical composition, volume, among others), and gives the order to the motor to activate one driver or the other for a specified period of time and in one direction or the other. Specifically, the sensors comprise different electronic transducers to transform thermal (NTC) or optical signals (phototransistors), among others, into electronic signals. Depending on whether the driving process is to be controlled to, for example, start when the fluid in the mixing area reaches a specific temperature, as soon as the transducer detects that said temperature has been reached, the processor sends a signal to start the driving process. Another example of actuation would be to start or stop the driving process when the fluid reaches a specific area of the microfluidic channels (19). Since the fluid interface changes the properties of light as it passes through the microfluidic channel, the passage of light through that area can be precisely verified by combining a LED with a phototransistor or a CMOS sensor. When this signal is detected, the microprocessor once again activates or deactivates the control signal for the driving processes.

The data collected by the sensors will be used to monitor the advance of the liquid within the microfluidic mixing channels (19), which will be used to provide feedback as to the actuation of the drivers (14) and, therefore, drive volumes in a precisely and safely controlled manner. In addition, the data collected by these sensors (8), such as integrated temperature sensors (NTC) or optical actuators (LEDs), is communicated to an electronic system accompanying the actuator platform, which will generate a closed circuit wherein each of the actions of the mechanical system is able to be spatio-temporally displayed, controlled and parameterised, as well as tracking the advance of the fluids (6) within the microfluidic mixing channels (19) in real time. This addition of a system display method can be carried out in several manners, including by connecting the actuator platform wirelessly to a portable device such as a mobile phone or tablet, introducing it into the analytical workflow through a wired connection to a computer, or by adding a separate screen for displaying the process. This way, the driving system is able to have both spatial and temporal control of the advance of fluids within the system using a system which can be programmed with software and is therefore not dependent on the manufacturing method, which provides the system with greater versatility.

Given that both the fluid inlet channels (4) and the mixing channels are under vacuum thanks to the plug (2), the plungers move the fluids within the mixing channels as they move. By making it easier for the fluids to be driven in both directions (forward and backward in the hole), there can be alternating movements within a small-length channel in order to produce the mixture, which saves significant space in the device which can be used for other purposes. Therefore, zig-zag channels or other complicated shapes are not necessary as in the state of the art.

The device is able to drive a controlled volume and even retract the fluid into the hole thanks to the electronic control of the plungers, which are connected to the plug, allowing driving in any direction of the drive shaft thanks to the vacuum in the driving area. This means that the fluid from each hole can be driven into several sections, be retracted once driven or driven just once depending on the volume of fluid to be dispensed, without having to modify the design of each hole and with the possibility of using the same hole as a fluid reservoir which need to be actuated several times throughout the protocol to be performed. This way, it is possible to normalise the design of the fluidic inlet thanks to the fact that the actuation of the plungers can be programmed, which adds a fundamental advantage both in the manufacturing and design of the device.

The fluid inlet hole (4) can optionally be fitted with a purge hole (11), which can be used to control the amount of fluid which is housed inside the hole.

The electronic connection of the external actuator platform makes it possible to add different additional functionalities if needed, such as a result display module or a wired or wireless connectivity system for transmitting the results to an external data storage and processing system.

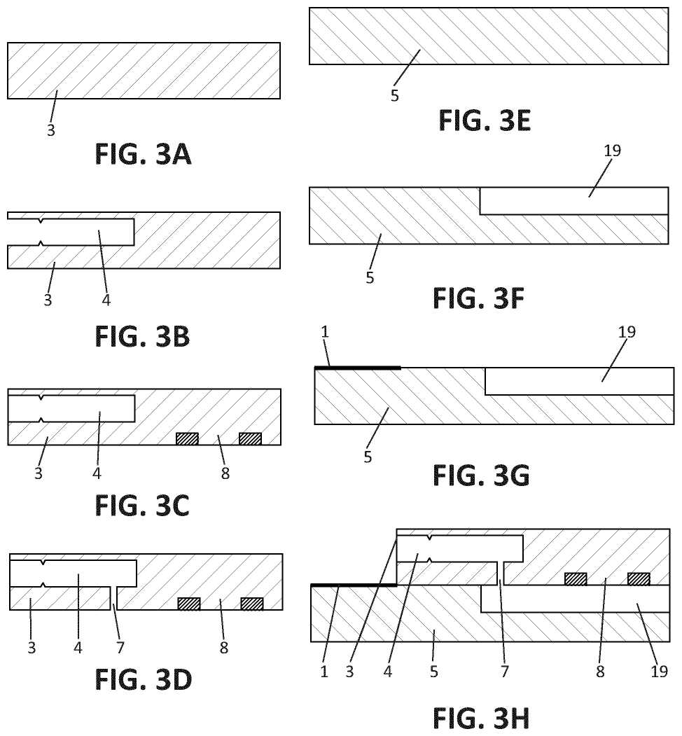

In reference to FIG. 3, the manufacturing of the device requires a base material (22) including but not limited to steel, methacrylate, polycarbonate, etc., which creates the base to which the upper driving area is subsequently coupled, which in turn contains the electronic connection to the external actuator platform (23), a driver (14) connected to a power supply (13) and a moving piston (15) which in turn will allow the controlled movement of the plunger (12).

On the other hand, the manufacturing of the lower area preferably starts with a base material, including but not limited to PMMA, wherein the fluid inlet hole (4) is made and the position of which is determined in the design of the device and manufactured by drilling, moulding or laser cutting and which is connected to the plunger (12) of the driving system; sensors (8) are then chemically welded to the data collection area, which is preferably located at the end of the microfluidic channels and, finally, a hole (7) is made which will serve as a connection between the inlet holes (4) of the upper area (3) and the microfluidic mixing channels (19) of the lower area (5) of the device. With regards to the lower layer (5), a hole is made which will serve as a microfluidic channel (19), after which the lower layer is metallised in order to establish the electronic connection (21) to the external actuator platform. In addition, there are one or more chambers (10) within this device for the inlet or outlet of different complementary fluids. Once the upper portion (3) and the lower portion (5) are manufactured, they are joined by welding to produce the complete lab-on-a-chip. The encapsulated fluids (6) and subsequently the closing plug (2), will be introduced into this structure. The closing plug (2) has the ability to break the encapsulation of the reagents if necessary, as it has one or more piercing elements on the contact surface thereof.

1. A micro fluidic device comprising a lab-on-a-chip with an upper fluid driving area (3) provided with at least two fluid driving systems (6) and a lower microfluidic mixing area (5) for mixing such fluids, both the fluid driving area and the microfluidic mixing area being made of a biocompatible material, wherein the driving area is provided with at least two fluid inlet holes (4) and respective moving plungers (12), each attached to a driver (14) for moving the plungers forward and backward, wherein the microfluidic mixing area is provided with at least one microchannel (19) for mixing fluids, and the fluid inlet holes and the microchannel (19) are joined by a communication hole (7), characterised in that it further comprises an external actuator platform (23), the drivers (14) being connected to the actuator platform (23) which is provided with an electronic board with a processor and a motor for actuating the drivers (14) to carry out several processes within the device at the same time, and the fluid inlet holes (4) are provided with a closing plug (2) inside.

2. The micro fluidic device according to claim 1, wherein the fluid inlet hole (4) is provided with a purge hole (11).

3. The micro fluidic device according to claim 1, wherein the closing plug (2) is provided with piercing elements.

4. The micro fluidic device according to claim 1, provided with physical and/or chemical sensors (8) in the microfluidic mixing area (5) above the microfluidic channels (19), and means for connecting the sensors to the processor of the actuator platform (23) in order to control the actuation of the drivers (14) based on the data provided by the sensors (8).
